(19) United States
(12) Patent Application Publication
(10) Pub. No.: US 2005/0012399 A1
(43) Pub. Date: Jan. 20, 2005

(54) Switch relay device and switch relay system

(75) Inventor: Yuji Yoshida, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/607,040

(22) Filed: Jun. 27, 2003

Related U.S. Application Data
(63) Continuation of application No. PCT/JP00/09289, filed on Dec. 27, 2000.

(51) Int. Cl. H02H 1/00

(52) U.S. Cl. 307/125

(57) ABSTRACT

A switch relay device and a switch relay system that enable device recognition without reconfiguring a network subject to connection while realizing a hot plug function. A network including a host personal computer is connected to a physical layer circuit. 1394 devices are connected to physical layer circuits. The physical layer circuit and the physical layer circuits are connected by a link layer circuit, and the physical layer circuit and the physical layer circuits are separated from each other. Thus, even if a bus reset occurs in the 1394 devices when the 1394 devices are connected or disconnected, the network is not reconfigured.

### CROSS-REFERENCE TO RELATED APPLICATIONS

This application is a continuation of PCT application number PCT/JP00/09289 filed on Dec. 27, 2000.

### BACKGROUND OF THE INVENTION

The present invention relates to a switch relay device and a switch relay system, and more particularly, to a switch relay device and a switch relay system functioning as a relay for a network provided with a hot plug function, such as an IEEE 1394.

In recent years, devices employing a high speed serial bus interface complying with the IEEE 1394 standard are employed in personal computers and peripheral equipment, such as a digital video camera and a color page printer, connected to personal computers. Devices employing IEEE 1394-compliant devices (hereafter referred to as 1394 devices) are provided with a plug and play function so that devices may be connected (plugged in) and disconnected (un-plugged) when the connected IEEE 1394 devices are performing data communication between one another. That is, when a 1394 device is connected to or disconnected from an active line (hot plugged) in a network configured by a plurality of 1394 devices, regardless of the state of other 1394 device interfaces (nodes), such as a state in which data transfer is being performed, bus resetting occurs in the nodes of every 1394 device. As a result, the nodes of every 1394 device connected to the network recognize the network configuration (topology) again. This configures a new network.

In the prior art, in a network configured by devices incorporating IEEE 1394-compliant devices, when one node is connected or disconnected, regardless of what state other nodes are in, such as a state in which data transfer is being performed, a bus reset occurs in every node. In nodes that are executing data transfer, such processing would be interrupted. When a bus reset occurs and initializes the bus in each node, the topology stored in each node is initialized. Subsequently, each node performs tree identification and self-identification to configure a new topology. When the network is reconfigured, each node issues a self-identification packet (self-ID packet), and a node ID is set for every node so that other nodes are identified. Accordingly, each node recognizes how many nodes exist in the network.

Further, the personal computer or the like (host) that controls the 1394 devices in the network recognize the 1394 devices connected to the network by reading their configuration ROM information (hereafter referred to as device information). Accordingly, the 1394 device, which serves as a host, identifies what kind of device the other 1394 devices configuring the topology are.

FIG. 13 is a schematic diagram showing a prior art relay device of a 1394 device.

The relay device 30 includes a plurality of IEEE 1394-compliant interface devices (four in the drawing). Each of the interface devices includes physical layer circuits (represented by PHY0, PHY1, PHY2, and PHY3) 31, 32, 33, and 34 to which 1394 devices are connected.

A 1394 network 35 (not shown) includes a plurality of 1394 devices (not shown) incorporating IEEE 1394-compliant interface devices. One of the 1394 devices is connected to the physical layer circuit 31 of the relay device 30.

The physical layer circuit 31 is connected to each physical layer circuit 32 and 33 by an interface bus 36. The physical layer circuit 32 is connected to a 1394 device 37, and the physical layer circuit 33 is connected to a 1394 device 38. Further, the physical layer circuit 33 is connected to the physical layer circuit 34.

The operation of the relay device 30 will now be discussed with reference to the flowchart of FIG. 15.

In step 40, the relay device 30 determines whether a new 1394 device has been connected to the physical layer circuits (PHY0 to PHY3) 31 to 34. If connected, the relay device 30 proceeds to step 41, and if not connected, the relay device 30 waits until one is connected.

In one example, when a new 1394 device 39 is connected to the physical layer circuit 34 as shown in FIG. 13, in step 41, the 1394 network 35 reconfigures a new 1394 network 35a, which includes the 1394 devices 37, 38, and 39. In the 1394 network 35, this interrupts processing in nodes that are transferring data (step 41a).

In step 42, every one of the nodes in the new 1394 network 35a issues a self-ID packet and sets a new node ID. As a result, all of the nodes perform recognition of the topology, such as the number of all the nodes existing in the new 1394 network 35a (step 42a).

In step 43, if there is no host personal computer, the relay device 30 proceeds to step 40 and waits until a new 1394 device is connected. If there is a host personal computer in step 43, the relay device 30 proceeds to step 44.

In step 44, the host personal computer transmits packets (data) to all of the 1394 devices to obtain device information from the 1394 devices and recognize every one of the 1394 devices in the new network 35a.

Then, the relay device 30 determines whether a new 1394 device is connected.

FIG. 14 is a schematic diagram of a prior art 1394 device.

A switch device 50 includes a plurality of (five in the drawing) connection ports 51 to 55.

A 1394 network 56 includes a plurality of 1394 devices (not shown), one of which is connected to the connection port 51 of the switch device 50. The 1394 devices 57 to 60 are connected to the connection ports 52 to 55.

The switch device 50 includes a switch 61. The switch 61 switches an interface bus 62 to connect one of the 1394 devices 57 to 60 to the 1394 network 56.

The operation of the switch device 50 will now be discussed in accordance with the flowchart of FIG. 16.

The operation performed during step 70 by the switching circuit 50 shown in FIG. 16 differs from the operation performed by the above relay device 30 in step 40. The other steps 71, 71a, 72, 72a, 73, and 74 are the same as steps 41, 41a, 42, 42a, 43, and 44 performed by the relay device 30.

In step 70, the switch device 50 determines whether the 1394 devices 57 to 60 connected to the 1394 network have been changed. For example, when the device connected to the 1394 network 56 changes from the 1394 device 57 to the 1394 device 58, as shown in FIG. 14, the 1394 network 56 is reconfigured as a new 1394 network 56a, which includes the new 1394 device 58. Then, the operations of steps 71 to 74 are performed in the same manner.

In the prior art relay device 30, each of the physical layer circuits (PYH0 to PYH3) 31 to 34 are connected to one another by the interface bus 36. Thus, when the 1394 devices 37 to 39 are connected to the relay device 30, the number of nodes in the new 1394 network 35 is increased by the number of interface devices included in the relay device 30. The increase in the number of nodes increases the load applied to the new 1394 network 35a. That is, in the new 1394 network, when data is transferred from a certain node, the amount of data that may be transferred from other nodes is limited. Further, when the number of nodes increases, a delay is produced in the data transfer due to the number of hops (position of the node).

When the 1394 devices 37 to 39 are connected to or disconnected from the relay device 30, which is connected to the 1394 network 35, the new network 35a is reconfigured. That is, when the 1394 devices 37 to 39 are connected or disconnected, a bus reset occurs in the 1394 devices performing data transfer in the 1394 network 35 and interrupts such processing. Accordingly, the 1394 device in which data transfer is interrupted must perform data transfer again after the new 1394 network 35a is reconfigured.

Further, if a host personal computer exists in the 1394 network 35 during step 43 of the above-mentioned FIG. 15, in addition to the 1394 devices 37 to 39, which connection or disconnection has been detected, the host personal computer must re-recognize the device information. This increases the load on the host personal computer.

The switch device 50 selects and connects one of the 1394 devices 57 to 60 to the 1394 network 56 with the switch 61. Thus, the number of nodes in the new 1394 network 56a do not become more than is necessary.

However, in the same manner as in the relay device 30, the interface bus 62 connects the interface devices in the switch device 50. Thus, there is a shortcoming in that when one of the 1394 devices 57 to 60 is connected or disconnected, the 1394 network 56 must be reconfigured.

It is an object of the present invention to provide a switch relay device and a switch relay system enabling device recognition that realizes the hot plug function without reconfiguring the network subject to connection.

### SUMMARY OF THE INVENTION

A first aspect of the present invention provides a switch relay device for connecting at least one new device to a network including at least one host. The switch relay device includes a first physical layer circuit connected to the network, a second physical layer circuit connected to each new device, and a link layer circuit, which is connected between the first physical layer circuit and the second physical layer circuit, to separate the first physical layer circuit and the second physical layer circuit from each other. The link layer circuit does not reconfigure the network when the at least one of a new device is connected or disconnected or when at least one of the new devices is switched.

A second aspect of the present invention provides a switch relay system for connecting at least one new device to a network including at least one host. The switch relay system includes a switch for switching at least one of the new devices, and a control unit for detecting whether the at least one new device is connected or whether at least one of the new devices is switched by the switch, and for not reconfiguring the network when connection or switching is detected.

A third aspect of the present invention provides a switch relay device for connecting a plurality of devices to a network including a host. The switch rely device includes a plurality of device physical layer circuits, each device physical layer circuit being for connection to a device, a network physical layer circuit for connection to the network, a link layer circuit connected between the network physical layer circuit and the device physical layer circuits, and a switch which selectively connects and disconnects the device physical layer circuits to a plurality of devices. The network physical layer circuit functions as a single node with respect to the network, even though the plurality of devices are connected or disconnected to the device physical layer circuits.

### BRIEF DESCRIPTION OF THE DRAWINGS

FIG. 1 is a schematic diagram showing the outer appearance of a switch relay device according to a first embodiment of the present invention.

FIG. 2 is a schematic diagram showing the internal configuration of the switch relay device.

FIG. 3 is a schematic diagram showing a system of the switch relay device.

FIG. 4 is a flowchart illustrating the operation of the switch relay device.

FIG. 5 is a block diagram illustrating an example in which video camcorders are connected to the switch relay device.

FIG. 6 is a block diagram illustrating an example in which video camcorders are connected to the switch relay device.

FIG. 7 is a block diagram illustrating an example in which hard disks are connected to a switch relay device according to a second embodiment of the present invention.

FIG. 8 is a block diagram illustrating an example in which data is transferred to the hard disks connected to the switch relay device.

FIG. 9 is a block diagram illustrating an example in which hard disks are connected to a switch relay device according to a third embodiment of the present invention.

FIG. 10 is a block diagram illustrating an example in which data is transferred to the hard disks connected to the switch relay device.

FIG. 11 is a block diagram illustrating an example in which devices are connected to a switch relay device according to a fourth embodiment of the present invention.

FIG. 12 is a block diagram illustrating an example in which devices are connected to a switch relay device according to a fifth embodiment of the present invention.

FIG. 13 is a schematic diagram illustrating the configuration of a relay device in the prior art.

FIG. 14 is a schematic diagram illustrating the configuration of a switch device in the prior art.

FIG. 15 is a flowchart illustrating the operation of the prior art relay device.

FIG. 16 is a flowchart illustrating the operation of the prior art switch device.

### DETAILED DESCRIPTION OF THE PREFERRED EMBODIMENTS

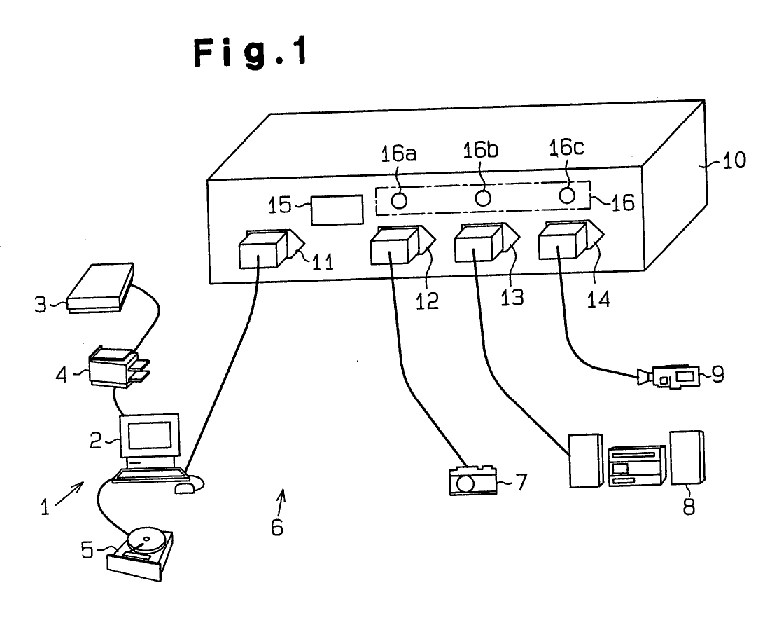

A switch relay device according to a first embodiment of the present invention will now be discussed with reference to FIGS. 1 to 6.

FIG. 1 is a schematic diagram showing the outer appearance of the switch relay device.

A first network 1 is configured by devices incorporating IEEE 1394-compliant interface devices (hereafter referred to as 1394 devices) 2 to 5. A second network 6 includes the first network 1, 1394 devices 7 to 9, and a switch relay device 10. In the present embodiment, the 1394 device 2 is, for example, a personal computer and functions as a host (hereafter referred to as a host personal computer) that controls other 1394 devices 3, 4, 5, 7, 8, and 9.

The switch relay device 10 includes a plurality of (four in the drawing) connection ports 11 to 14, a switch 15, and an indication device 16.

The first network 1 is connected to the connection port 11, and the 1394 devices 7 to 9 are connected to the connection ports 12 to 14, respectively.

The switch 15 selects and connects one of the connection ports 12 to 14 to the connection port 11.

The indication device 16 includes indication devices 16a to 16c. The indication devices 16a to 16c shows in a recognizable manner whether any one of the connection ports 12 to 14 is connected to the connection port 11.

In other words, the switch relay device 10 connects one of the 1394 devices, which is selected by the switch 15, to the first network 1 and configures a second network 6.

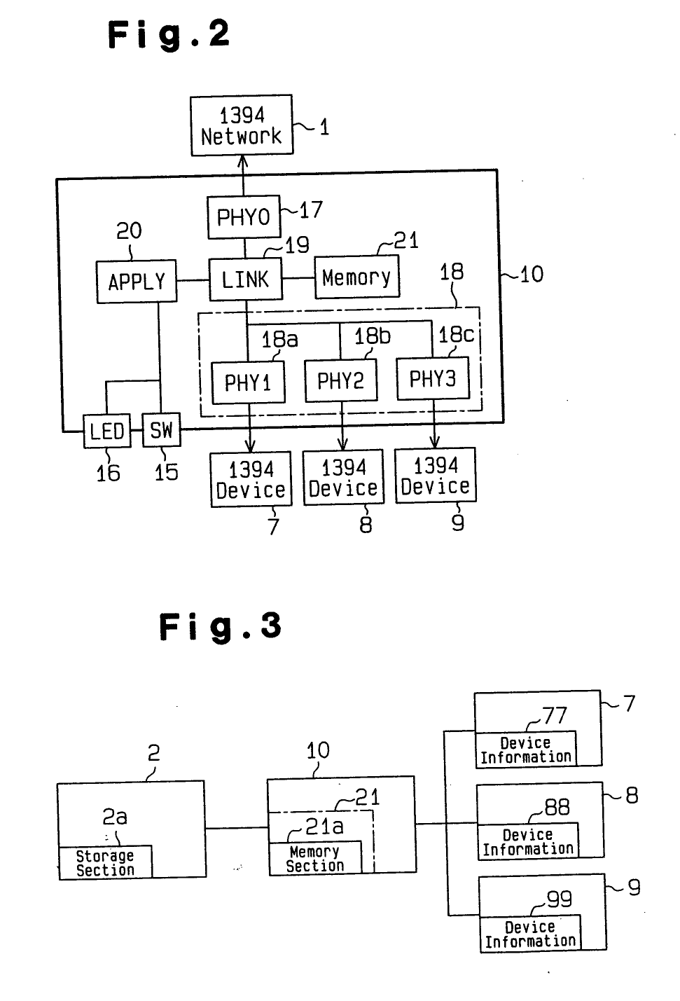

FIG. 2 is a schematic diagram illustrating the internal configuration of the switch relay device.

The switch relay device 10 includes physical layer circuits 17 and 18, a link layer circuit 19, an application layer circuit 20, and a memory device 21.

The physical layer circuit (represented by PHY0 in the drawing) 17 is connected to the connection port 11 (not shown). When receiving a packet (data) from the first network 1 (represented by 1394 network in the drawing), the physical layer circuit 17 converts its electric signal to a logic signal, which is sent to the link layer circuit 19 (represented by LINK in the drawing). Further, the physical layer circuit 17 transmits a packet, which is an electric signal generated by converting the logic signal from the link layer circuit 19, to the first network 1.

The physical layer circuit 18 includes a plurality of (three in the drawing) physical layer circuits (represented by PHY1, PHY2, and PHY3) 18a to 18c. The physical layer circuits 18a to 18c are connected to the connection ports 12 to 14 (not shown), respectively. When each physical layer circuit 18a to 18c receives a packet from the corresponding 1394 device 7 to 9, the physical layer circuit 18a to 18c converts its electric signal to a logic signal and sends the logic signal to the link layer circuit 19. Each of the physical layer circuits 18a to 18c transmits a packet, in which the logic signal from the link layer circuit 19 is converted to an electric signal, to the corresponding 1394 devices 7 to 9.

The link layer circuit 19 manages the packets received and transmitted by the physical layer circuits 17 and 18 (physical layer circuits 18a to 18c) and stores the data that the link layer circuit 19 itself receives in a memory device 21 (represented by Memory in the drawing). Further, the link layer circuit 19 outputs the packets stored in the memory device 21 during data transmission to the physical layer circuit 17 or the physical layer circuit 18 during the transmission of data. That is, the switch relay device 10 transmits data to and receives data from the physical layer circuit 17 and the physical layer circuit 18 through the link layer circuit 19.

An application layer circuit 20 (represented by APPLY in the drawing) stores a program for controlling the physical layer circuits 17 and 18 and the link layer circuit 19. Accordingly, the application layer circuit 20 controls the transfer of data to and from the physical layer circuit 17 and the physical layer circuit 18 through the link layer circuit 19. That is, the method for using and controlling the 1394 devices 7 to 9, which will be described later, is determined by the application layer circuit 20.

The switch (represented by SW in the drawing) 15 and the indication device (represented by LED in the drawing) 16 are connected to the application layer circuit 20. Accordingly, the application layer circuit 20, for example, lights the indication devices 16a to 16c in correspondence with the selected 1394 devices 7 to 9. When the switch 15 selects one of the 1394 devices 7 to 9, the application layer circuit 20 determines how to transfer packets to the selected device.

FIG. 3 is a schematic diagram illustrating a system of the switch relay device.

When the 1394 devices 7 to 9 are connected to the physical layer circuits 18a to 18c (not shown), the switch relay device 10 reads and stores configuration ROM information (device information) 77, 88, and 99 of the respective 1394 devices 7 to 9 in a memory section 21a of the memory device 21. The device information 77, 88, and 99 temporarily stored in the memory section 21a remains stored even after the 1394 devices 7 to 9 are removed from the switch relay device 10. Accordingly, when the 1394 devices 7 to 9 disconnected from the switch relay device 10 are re-connected, the switch relay device 10 reads minimal information for the device information 77, 88, and 99 of the 1394 devices 7 to 9 to recognize the 1394 devices 7 to 9.

If there is a request for the device information 77, 88, and 99 from the host personal computer 2 when reconfiguring the first network 1 (not shown), the switch relay device 10 stores the device information 77, 88, and 99, which are stored in the memory section 21a, in a storage section 2a of the host personal computer 2. In this state, when one of the 1394 devices 7 to 9 is selected by the switch 15 (not shown) or when one of the selected 1394 devices 7 to 9 is switched by the switch 15, the device information 77, 88, or 99 of the selected or switched one of the 1394 devices 7 to 9 is stored in the storage section 2a. As a result, the host personal computer 2 recognizes the 1394 devices 7 to 9 connected to the switch relay device 10.

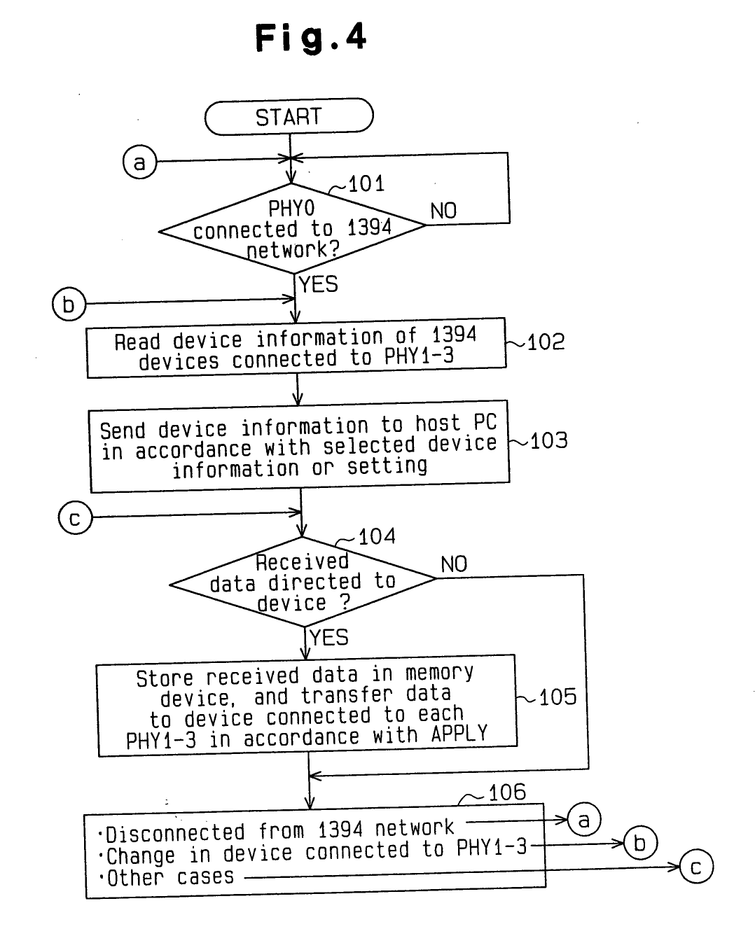

FIG. 4 is a flowchart illustrating the operation of the switch relay device.

In step 101, the switch relay device 10 determines whether the first network (1394 network) 1, in which the host personal computer 2 exists, is connected to the physical layer circuit (PHY0) 17 and proceeds to step 102 when the first network 1 is connected. In step 101, if the first network 1 is not connected, the switch relay device 10 waits until it is connected.

In step 102, the switch relay device 10 reads the device information 77, 88, and 99 of the 1394 devices 7 to 9, and stores the device information 77, 88, and 99 in the memory device 21 (not shown).

In step 103, the host personal computer 2 requests the device information 77, 88, and 99. In response to the request, the switch relay device 10 stores the device information 77, 88, and 99 in the host personal computer 2. In this state, when one of the 1394 devices 7 to 9 is selected by the switch 15 (not shown) as described above or if one of the 1394 devices 7 to 9 is switched, one among the device information 77, 88, and 99 of the selected or switched 1394 devices 7 to 9 is stored in the host personal computer 2. Based on the device information 77, 88, and 99 stored in the host personal computer 2, the host personal computer 2 generates data that is transmitted to the 1394 devices 7 to 9.

In step 104, the switch relay device 10 determines whether it has received data from the first network 1. The switch relay device 10 proceeds to step 105 if it has received data and proceeds to step 106 if it has not received data.

In step 105, the switch relay device 10 stores the received data in the memory device 21 and transfers the received data to the 1394 devices 7 to 9 based on the control program of the application layer circuit 20.

In step 106, the switch relay device 10 proceeds to step 101 if the physical layer circuit 17 and the first network 1 are disconnected and waits until the physical layer circuit 17 is re-connected to the first network 1. Further, in step 106, the switch relay device 10 proceeds to step 102 when a 1394 device other than the 1394 devices 7 to 9 is connected to the physical layer circuits (PHY1 to PHY3) and reads the device information of the newly connected 1394 device. Further, in step 106, in cases other than those described above, the switch relay device 10 proceeds to step 104 and waits for the received data from the first network 1.

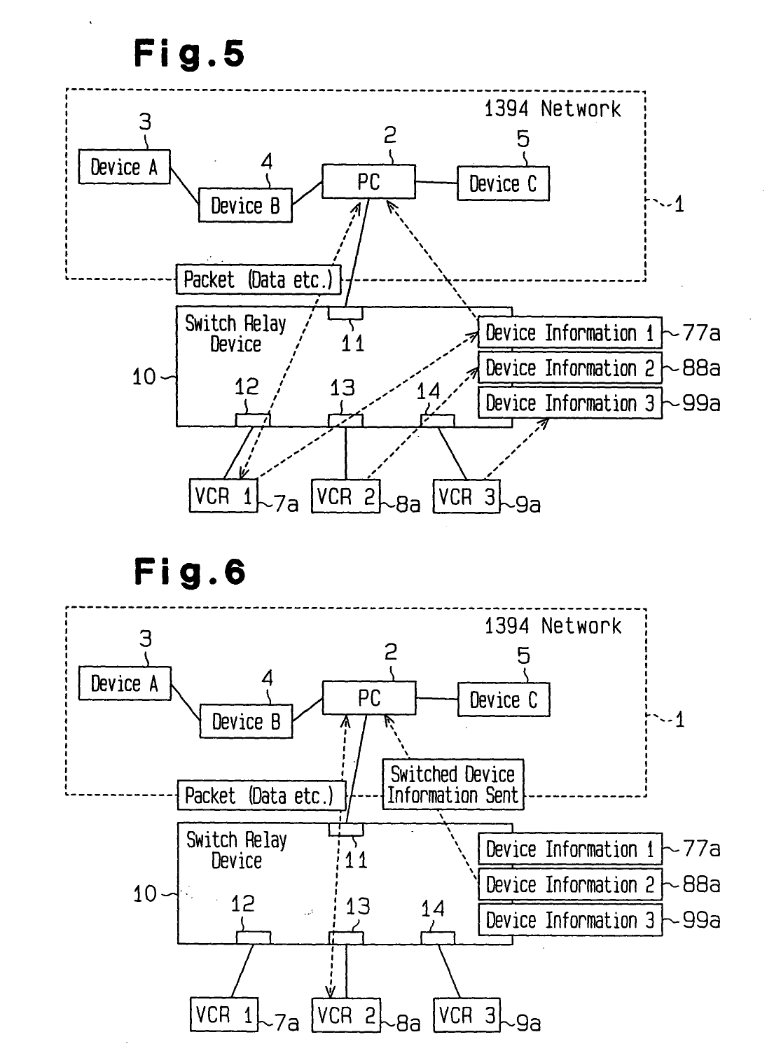

An example in which first to third video camcorders (represented by VCR 1, VCR 2, and VCR 3 in the drawings) are used as the 1394 devices 7 to 9, which are connected to the connection ports 12 to 14 of the switch relay device 10, will now be discussed with reference to FIGS. 5 and 6. In the first network (represented by 1394 network in the drawing) 1 shown in FIGS. 5 and 6, PC corresponds to the host personal computer 2, and Device A, Device B, and Device C correspond to the 1394 devices 3 to 5.

When the switch relay device 10, to which the first to third video camcorders 7a, 8a, and 9a are connected, is connected to the first network 1, the first network 1 is reconfigured. In this state, the first network 1 recognizes only the node of the physical layer circuit 17 (not shown), which is connected to the host personal computer 2. Thus, a bus reset does not occur in the nodes of the first to third video camcorders 7a, 8a, and 9a.

The host personal computer 2 transmits a packet to the switch relay device 10 requesting the device information (represented by device information 1, 2, and 3 in the drawing) 77a, 88a, and 99a of the first to third video camcorders 7a, 8a, and 9a. In response to the request, the switch relay device 10 reads the device information 77a, 88a, and 99a of the first to third video camcorders 7a, 8a, and 9a and stores the device information 77a, 88a, and 99a in the memory device 21 (not shown).

As an example, it is presumed here that the switch 15 has selected the first video camcorder 7a. As a result, the switch relay device 10 sends the device information 77a for the first video camcorder 7a to the host personal computer 2. Accordingly, the host personal computer 2 recognizes the first video camcorder 7a from the first to third video camcorders 7a, 8a and 9a connected to the switch relay device 10.

Then, as shown in FIG. 5, when the physical layer circuit 17 (not shown) receives a packet, which controls the first video camcorder 7a, from the host personal computer 2, the switch relay device 10 transfers the packet to the first video camcorder 7a via the link layer circuit 19 (not shown) from the physical layer circuit 18a (not shown). When the switch relay device 10 receives image data or the like from the first video camcorder 7a, the switch relay device 10 transmits the image data to the first network 1 based on the functions of the application layer circuit 20.

FIG. 6 shows an example in which the switch 15 switches the device connected to the first network 1 from the first video camcorder 7a to the second video camcorder 8a.

When the switch 15 selects the second video camcorder 8a, the video camcorder 8a issues a bus reset. In this state, the first network 1 is not reconfigured.

More specifically, as illustrated in FIG. 2, the physical layer circuit 17 is connected to the physical layer circuits 18a to 18c by the link layer circuit 19. That is, the node of the host personal computer 2 connected to the physical layer circuit 17 is separated from the nodes of the first to third video camcorders 7a, 8a, and 9a connected to the physical layer circuits 18a to 18c by the link layer circuit 19. Thus, if the second video camcorder 8a issues a bus reset, information for the change in its node ID is not sent to the first network 1. Accordingly, when one of the first to third video camcorders 7a, 8a, and 9a connected to the first network 1 is switched by the switch 15, the first network 1 is not reconfigured.

When the second video camcorder 8a is selected, the switch relay device 10 stores the device information 88a, which is prestored in the memory device 88a, in the host personal computer 2. Accordingly, the host personal computer 2 recognizes the second video camcorder 8a from the first to third video camcorders 7a, 8a, and 9a connected to the switch relay device 10.

When the selected second video camcorder 8a is disconnected from the switch relay device 10, the switch relay device 10 automatically selects the remaining first and third video camcorders 7a and 9a through the function of the application layer circuit 20 (not shown). Also in this state, the first network 1 is not reconfigured. Further, when a video camcorder other than the first to third video camcorders 7a, 8a, and 9a is connected to the switch relay device 10, the device information for the newly connected video camcorder is sent to the host personal computer 2. Also in this state, the first network 1 is not reconfigured.

The features of the switch relay device and the switch relay system according to the first embodiment of the present invention will now be described.

(1) The first network 1, which includes the host personal computer 2, is connected to the physical layer circuit 17. The 1394 devices 7 to 9 are connected to the physical layer circuits 18a to 18c. The physical layer circuit 17 is connected to the physical layer circuits 18a to 18c by the link layer circuit 19, and the physical layer circuit 17 is separated from the physical layer circuits 18a to 18c. Thus, even if a bus reset occurs in the 1394 devices 7 to 9 due to the connection or disconnection of the 1394 devices 7 to 9, the first network 1 is not reconfigured. Accordingly, even if a 1394 device transferring data exists in the first network 1, the switch relay device 10 guarantees the transfer of data without causing problems in the data transfer.

(2) The switch 15 selects one of the 1394 devices 7 to 9 while restricting reconfiguring the first network 1. In other words, even if the connected 1394 devices 7 to 9 are switched in accordance with the purpose of usage, the network does not stop functioning.

(3) Since the first network 1 is restricted to reconfigure, the host personal computer 2 does not have to recognize the 1394 devices 3 to 5 in the first network 1 again. This reduces the load applied to the host personal computer 2.

(4) When the switch 15 selects one of the 1394 devices 7 to 9, the switch relay device 10 sends the information of the selected device to the host personal computer 2. Thus, for example, when the 1394 device 7 is selected, the host personal computer 2 recognizes the switch relay device 10 as the 1394 device 7. In this state, the 1394 devices 8 and 9, which are connected to the switch relay device 10, are not recognized by the host personal computer 2. Accordingly, the number of nodes of the devices that are not used is not increased. This prevents the load on the host personal computer 2 from becoming unnecessarily large and reduces the load of the first network 1.

(5) The switch relay device 10 includes the memory device 21, which stores the device information 77, 88, and 99 of the 1394 devices 7 to 9. Thus, when the 1394 devices 7 to 9 are disconnected and then re-connected, all of the device information does not have to be read.

(6) The number of nodes connected to the switch relay device 10 may be one. This prevents the data transfer in the second network 6 from being delayed.

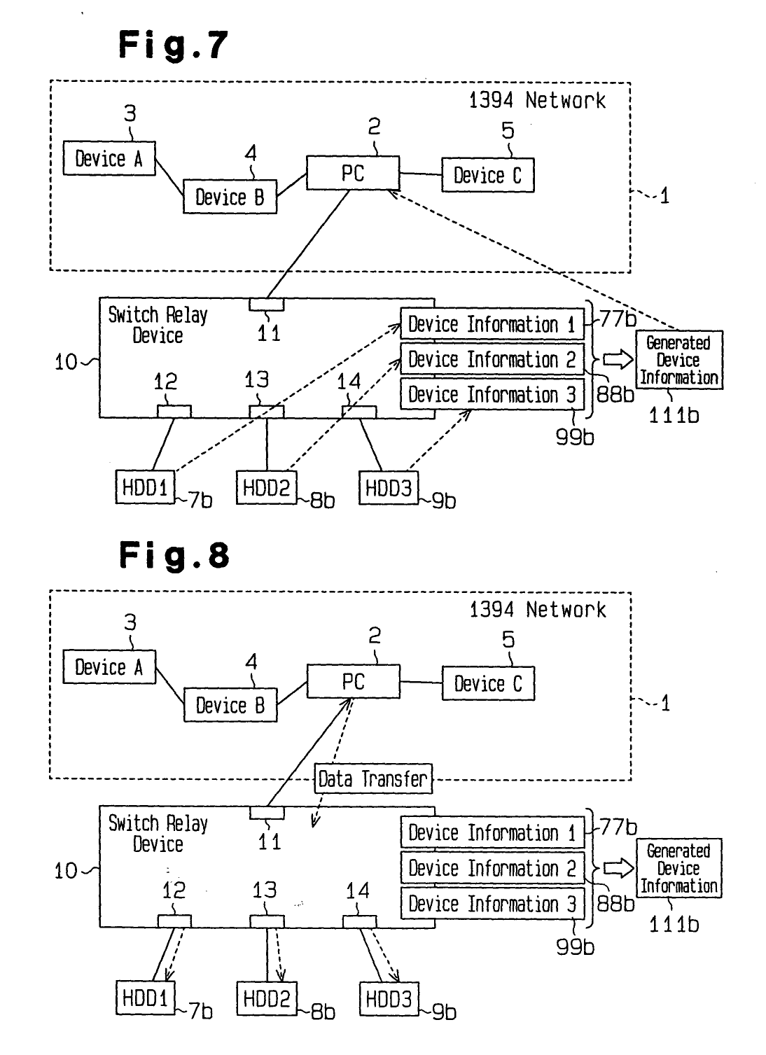

A switch relay device according to a second embodiment of the present invention will now be discussed with reference to FIGS. 7 and 8. In the present embodiment, elements that are like those in the first embodiment are denoted with the same reference numbers and will not be described in detail.

FIGS. 7 and 8 show an example in which first to third hard disks (represented by HDD1, HDD2, and HDD3 in the drawings) 7b, 8b, and 9b are connected to the connection ports 12 to 14 of the switch relay device 10 as the 1394 devices 7 to 9.

When the switch relay device 10, to which the first to third hard disks 7b, 8b, and 9b are connected, is connected to the first network 1, the first network 1 is reconfigured. In the same manner as in the first embodiment, a bus reset does not occur in the nodes of the first to third hard disks 7b, 8b, and 9b.

Further, in the same manner, the switch relay device 10 stores device information (represented by device information 1, 2, and 3 in the drawing) 77b, 88b, and 99b of the first to third hard disks 7b, 8b, and 9b in the memory device 21 (not shown).

For example, it is presumed here that the switch 15 is not selecting any one of the first to third hard disks 7b, 8b, and 9b.

The switch relay device 10 generates new configuration ROM information (device information) 111b as a pseudo-hard disk based on the device information 77b, 88b, and 99b in accordance with the functions of the application layer circuit 20 (not shown).

For example, if the capacity of the first to third hard disks 7b, 8b, and 9b is 10 GB (gigabits), the switch relay device 10 converts the capacity of about 30 GB as a hard disk to new device information 111b and sends the device information 111b to the host personal computer 2.

As shown in FIG. 8, when the host personal computer 2 starts transferring data in accordance with the device information 111b, the data is stored in the first hard disk 7b in accordance with the function of the application layer circuit 20 (not shown) in the switch relay device 10. Afterward, when detecting that there is no available memory space in the first hard disk 7b, the switch relay device 10 stores the data in the second hard disk 8b. Then, when the second hard disk 8b runs out of space, the switch relay device 10 stores the data in the third hard disk 9b.

The features of the switch relay device and the switch relay system according to the second embodiment of the present invention will now be described. The switch relay device 10 of the present embodiment has the same features as those of the switch relay device 10 according to the first embodiment.

(1) The application layer circuit 20 of the switch relay device 10 is provided with a function for generating a single piece of new device information based on the device information 77, 88, and 99 of the 1394 devices 7 to 9 when the switch 15 selects none of the 1394 devices 7 to 9. By sending the new single piece of device information to the host personal computer 2, the device that transfers the data from the host personal computer 2 is automatically selected and switched to.

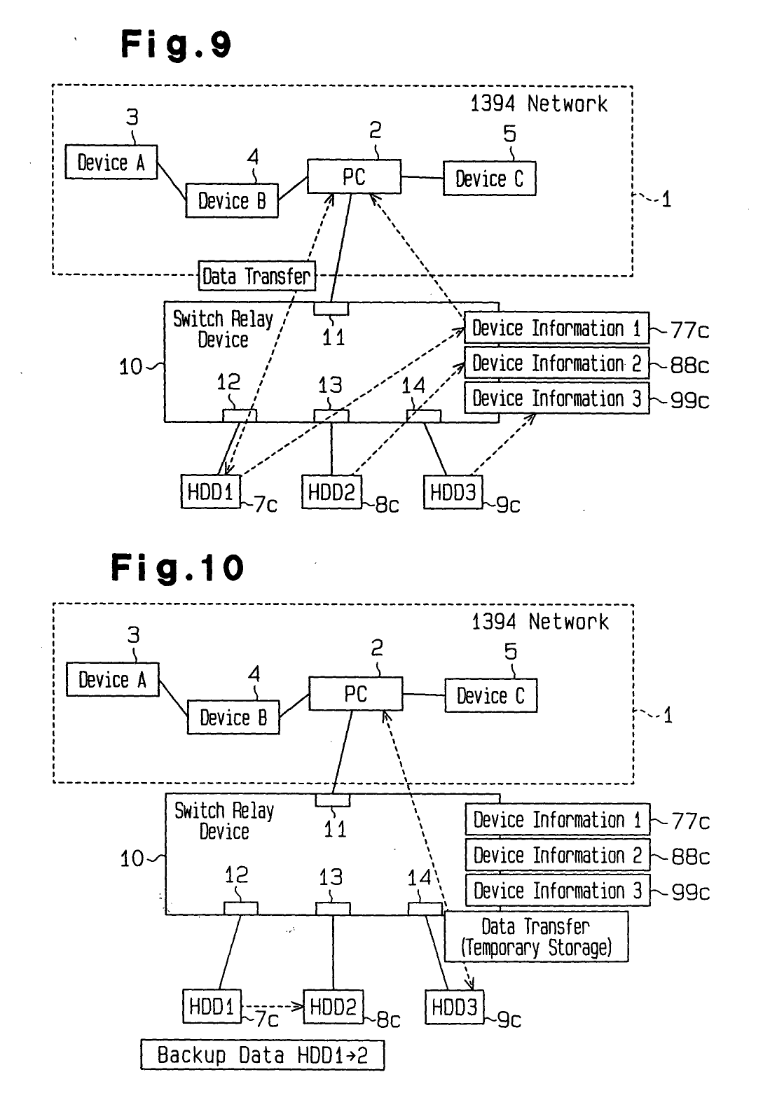

A switch relay device according to a third embodiment of the present invention will now be discussed with reference to FIGS. 9 and 10. In the present embodiment, elements that are like to those in the first embodiment are denoted with the same reference numbers and will not de described in detail.

FIGS. 9 and 10 show an example in which first to third hard disks (represented by HDD1, HDD2, and HDD3 in the drawings) 7c, 8c, and 9c are connected to the connection ports 12 to 14 of the switch relay device 10 as the 1394 devices 7 to 9.

When the switch relay device 10, to which the first to third hard disks 7c, 8c, and 9c are connected, is connected to the first network 1, the first network 1 is reconfigured. In the same manner as in the first embodiment, a bus reset does not occur in the nodes of the first to third hard disks 7c, 8c, and 9c.

Further, in the same manner, the switch relay device 10 stores device information (represented by device information 1, 2, and 3 in the drawing) 77c, 88c, and 99c of the first to third hard disks 7c, 8c, and 9c in the memory device 21 (not shown).

For example, it is presumed here that the first hard disk 7c is a device that operates at a speed higher than that of the second hard disk 8c and that the second hard disk 8c is a device having a capacity that is greater than that of the first hard disk 7c.

When the switch 15 is selecting the first hard disk 7c, the switch relay device 10 sends the device information 77c of the first hard disk 7c to the host personal computer 2.

When receiving data from the host personal computer 2, the switch relay device 10 stores the data in the first hard disk 7c, which is selected by the switch 15.

Afterward, when detecting that there is no available memory space in the first hard disk 7c, as shown in FIG. 10, the switch relay device 10 stores the data in the third hard disk 9c in accordance with the function of the application layer circuit 20 (not shown). That is, the application layer circuit 20 detects that there is no available memory space in the first hard disk 8c, automatically switches the selection to the third hard disk 9c, and temporarily stores data in the third hard disk 9c. In addition to temporarily storing data, the application layer circuit 20 transfers the data stored in the first hard disk 7c to the second hard disk 8c.

After storing all of the data that is stored in the first hard disk 7c in the second hard disk 8c, the application layer circuit 20 stores the data received from the host personal computer 2 again in the first hard disk 7c, which is selected by the switch 15. Further, the application layer circuit 20 transfers the data temporarily stored in the third hard disk 9c to the first hard disk 7c.

By providing the application layer circuit 20 with such a function, the switch relay device 10 operates the second hard disk 8c as a backup device.

The features of the switch relay device and the switch relay system according to the third embodiment of the present invention will now be described. The switch relay device 10 of the present embodiment has the same features as those of the switch relay device 10 according to the first embodiment.

(1) When, for example, detecting that there is no available memory space for storing data in the 1394 device 7 selected by the switch 15, the application layer circuit 20 of the switch relay device 10 temporarily stores data in the other 1394 device 9 and transfer the data of the 1394 device 7 to the 1394 device 8. When the application layer circuit 20 is provided with such a function, the 1394 device 7 does not have to monitor the available memory space in which data is stored to perform switching with the switch 15.

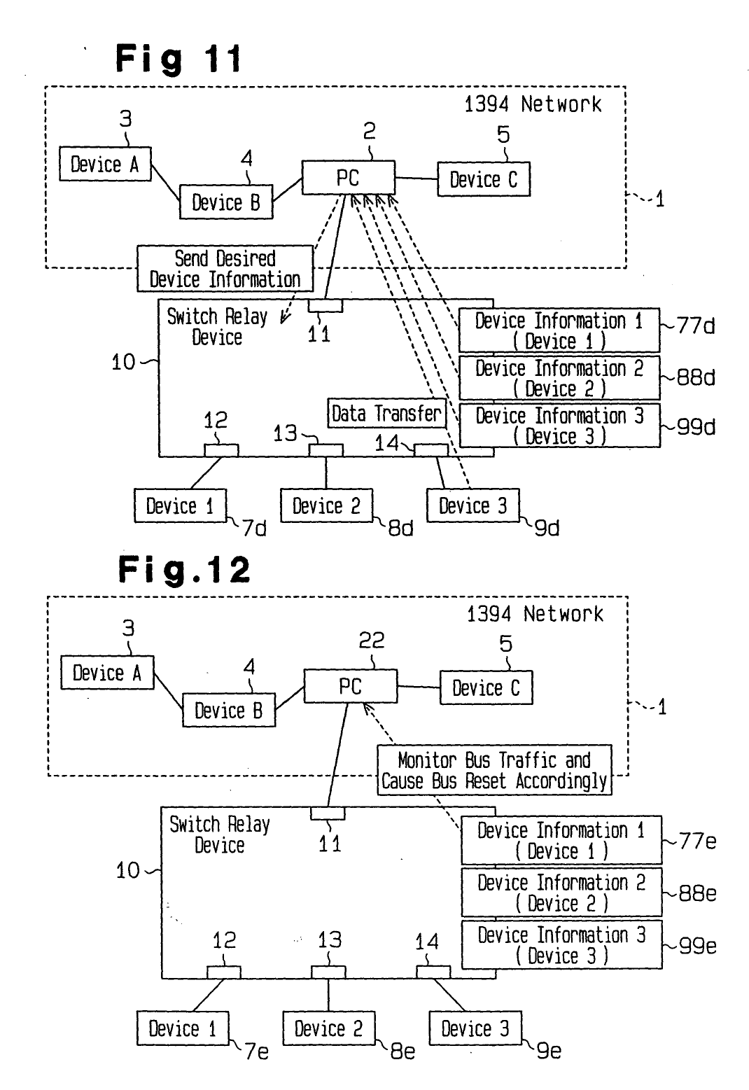

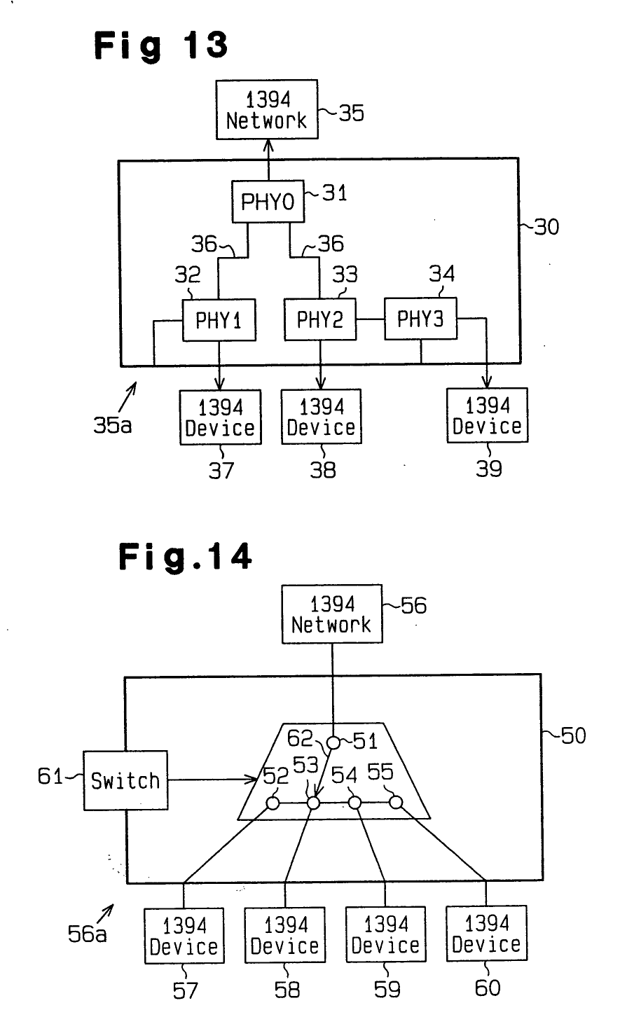

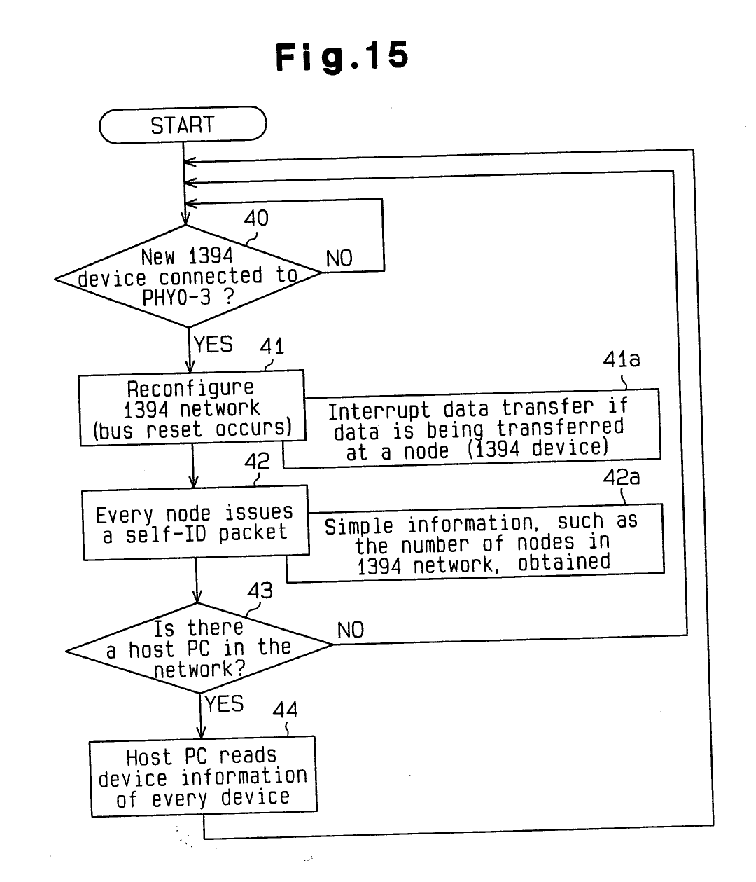

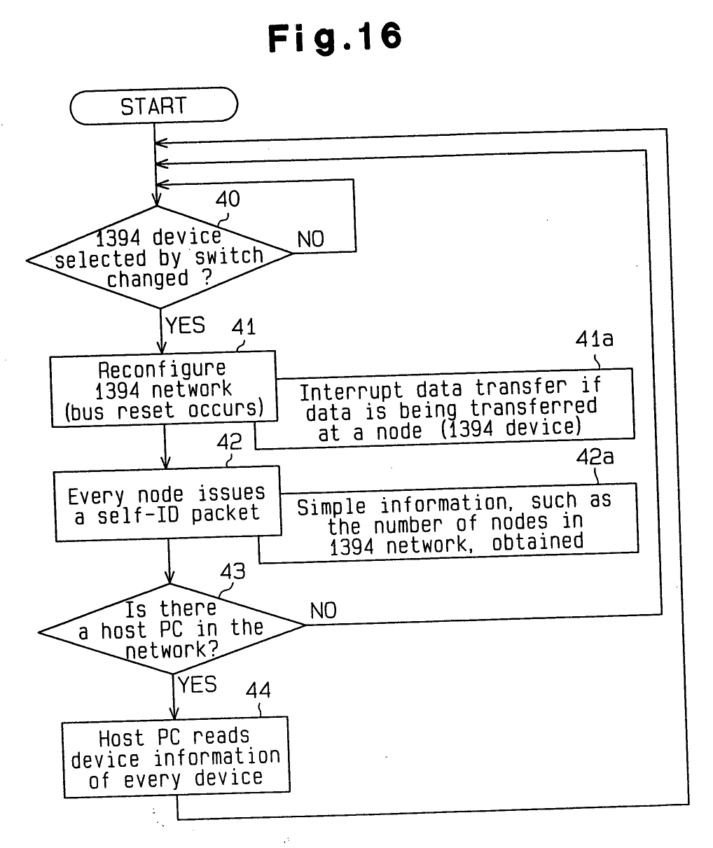

A switch relay device according to a fourth embodiment of the present invention will now be discussed with reference to FIG. 11. In the present embodiment, elements that are like those in the first embodiment are denoted with the same reference numbers and will not de described in detail.

FIG. 11 shows an example in which first to third devices (represented by Device 1, Device 2, and Device 3 in the drawings) 7d, 8d, and 9d are connected to the connection ports 12 to 14 of the switch relay device 10 as the 1394 devices 7 to 9.

When the switch relay device 10, to which the first to third devices 7d, 8d, and 9d are connected, is connected to the first network 1, the first network 1 is reconfigured. In the same manner as in the first embodiment, a bus reset does not occur in the nodes of the first to third hard devices 7d, 8d, and 9d.

Further, in the same manner, the switch relay device 10 stores device information (represented by device information 1, 2, and 3 in the drawing) 77d, 88d, and 99d of the first to third devices 7d, 8d, and 9d in the memory device 21 (not shown).

For example, it is presumed here that none of the first to third devices 7d, 8d, and 9d are selected by the switch 15. The switch relay device 10 sends all of the device information 77d, 88d, and 99d of the first to third devices 7d, 8d, and 9d to the host personal computer 2 in accordance with the function of the application layer circuit 20 (not shown). As a result, the host personal computer 2 recognizes the first to third devices 7d, 8d, and 9d that are connected to the switch relay device 10.

The host personal computer 2 selects which one of the first to third devices 7d, 8d, and 9d to use based on their device information 77d, 88d, and 99d. For example, presuming that the host personal computer 2 has selected the third device 9d, the host personal computer 2 sends the device information 99d for the third device 9d to the switch relay device 10. The switch relay device 10 receives the device information 99d. Based on the device information 99d, the application layer circuit 20 (not shown) transfers the data received from the host personal computer 2 to the third device 9d, as shown in FIG. 11.

The features of the switch relay device and the switch relay system according to the fourth embodiment of the present invention will now be described. The switch relay device 10 of the present embodiment has the same features as those of the switch relay device 10 according to the first embodiment.

(1) The application layer circuit 20 of the switch relay device 10 sends all of the device information 77, 88, and 99 of the 1394 devices 7 to 9 to the host personal computer 2 and transfers data to the device selected by the host personal computer 2. That is, the 1394 device that transfers data is switched to one of the 1394 devices 7 to 9 by operating the host personal computer 2.

A switch relay device according to a fifth embodiment of the present invention will now be discussed with reference to FIG. 12. In the present embodiment, a host personal computer 22 in the first network 1 differs from the host personal computer 2 of the first to fourth embodiment in that it is a personal computer that does not have a storage section 2a for storing the device information 77, 88, and 99 of the 1394 devices 7 to 9. The remaining parts that are like those in the first embodiment are denoted with the same reference numbers and will not be described in detail.

FIG. 12 shows an example in which first to third devices (represented by Device 1, Device 2, and Device 3 in the drawings) 7e, 8e, and 9e are connected to the connection ports 12 to 14 of the switch relay device 10 as the 1394 devices 7 to 9.

When the switch relay device 10, to which the first to third devices 7e, 8e, and 9e are connected, is connected to the first network 1, the first network 1 is reconfigured. In the same manner as in the first embodiment, a bus reset does not occur in the nodes of the first to third hard devices 7e, 8e, and 9e.

Further, in the same manner, the switch relay device 10 stores device information (represented by device information 1, 2, and 3 in the drawing) 77e, 88e, and 99e for the first to third devices 7e, 8e, and 9e in the memory device 21 (not shown).

For example, it is presumed here that the switch 15 switches to the first device 7e from the second device 8e. In this state, since there is no storage section 2a in the host personal computer 22, the device information 77e of the switched first device 7e is not sent to the host personal computer 22.

As a result, due to the functions of the application layer circuit 20 (not shown), the switch relay device 10 detects the bus traffic state in the first network 1. That is, the switch relay device 10 determines which one of the host personal computer 22 and the 1394 devices (represented by Device A, Device B, and Device C) in the first network 1 is transferring data.

When it is determined that data is not being transferred, the switch relay device 10 causes a bus reset to occur in the host personal computer 22. The host personal computer 22, in which a bus reset occurs, reconfigures the first network 1 and requests the device information from the switch relay device 10. In response to the request, the switch relay device 10 reads the device information 77e of the first device 7e selected by the switch 15 from the memory section 21 (not shown) and sends the device information 77e to the host personal computer 22. Accordingly, the host personal computer 22 recognizes the first device 7e.

The feature of the switch relay device and the switch relay system according to the fifth embodiment of the present invention will now be described.

(1) When the host personal computer 22 does not have a storage section 2a for storing the device information 7 to 9, the application layer circuit 20 of the switch relay device 10 causes a bus reset to occur in the host personal computer 22 so that the host personal computer 22 performs device recognition. In this state, the switch relay device 10 monitors the traffic state of the first network 1 and causes a bus reset to occur in the host personal computer 22 when determining that data is not being transferred. Thus, in the first network, the 1394 devices that are transferring data are not affected.

In each of the above embodiments, the host is a personal computer. However, other 1394 devices may be used to perform control.

In each of the above embodiments, the physical layer circuit 18 has three physical layer circuits 18a to 18c. However, the physical layer circuit 18 may have four or more physical layer circuits.

The 1394 devices connected to the connection ports 12 to 14 are not limited to those of the above embodiments and may be a digital video camcorder (DVC) or the like.

In each of the above embodiments, there may be two or more hosts in the first network 1.

1. A switch relay device for connecting at least one new device to a network including at least one host, the switch relay device comprising:
a first physical layer circuit connected to the network;
a second physical layer circuit connected to each new device; and
a link layer circuit, which is connected between the first physical layer circuit and the second physical layer circuit, to separate the first physical layer circuit and the second physical layer circuit from each other, wherein the link layer circuit does not reconfigure the network when the at least one of a new device is connected or disconnected or when at least one of the new devices is switched.

2. The switch relaying device according to claim 1, further comprising a switch for switching the at least one of the new devices, wherein the link layer circuit transfers data between the first physical layer circuit and one of the second physical layer circuits that is connected the new device based on the switching operation of the switch.

3. The switch relaying device according to claim 2, further comprising a memory device for reading device information from the new device and storing the device information.

4. The switch relay device according to claim 3, further comprising an application layer circuit for sending one of the device information selected by the switch to the host based on the device information, which is prestored, and for controlling data transfer between the first physical layer circuit and the second physical layer circuit.

5. The switch relay device according to claim 4, wherein the application layer circuit includes a generation unit for generating general purpose device information based on the device information.

6. The switch relay device according to claim 4, wherein the application layer circuit includes a transferring and saving unit for determining whether there is available memory space in a first new device selected by the switch to store data received from the host and for transferring the data stored in the first new device to a second new device while saving the data from the host in a third new device when there is no available memory space in the first new device.

7. The switch relay device according to claim 4, wherein the application layer circuit includes a sending unit for sending one of the device information selected by the host to the host based on the prestored device information.

8. The switch relay device according to claim 4, wherein the application layer circuit includes a delaying unit for determining whether data is being transferred in the network when one of the new devices is switched by the switch and for delaying the occurrence of a bus reset when the data is being transferred until the data transfer process ends.

9. A switch relay system for connecting at least one new device to a network including at least one host, the switch relay system comprising:
a switch for switching at least one of the new devices; and
a control unit for detecting whether the at least one new device is connected or whether at least one of the new devices is switched by the switch, and for not reconfiguring the network when connection or switching is detected.

10. The switch relay system according to claim 9, wherein when the connection or switching of the new device is detected, the control unit causes a bus reset to occur only in the new device in which the connection or switching is detected.

11. The switch relay system according to claim 9, wherein the control unit reads device information of the new device, detects whether one of the new devices is selected by the switch, sends the device information of the selected new device to the host of the network when one of the new devices is selected, and sends the device information of all of the new devices when none of the new devices is selected.

12. A switch relay device for connecting a plurality of devices to a network including a host, the switch rely device comprising:
a plurality of device physical layer circuits, each device physical layer circuit being for connection to a device;
a network physical layer circuit for connection to the network;
a link layer circuit connected between the network physical layer circuit and the device physical layer circuits; and
a switch which selectively connects and disconnects the device physical layer circuits to a plurality of devices, wherein the network physical layer circuit functions as a single node with respect to the network, even though the plurality of devices are connected or disconnected to the device physical layer circuits.

13. The switch relay device according to claim 12, wherein the link layer circuit transfers data between the network physical layer circuit, and one of the device physical layer circuits to which a device is connected in accordance with the selection of the switch.

14. The switch relay device according to claim 12, further comprising a memory device having a memory for reading device information from a new device when connected to a device physical layer circuit and storing the device information.

15. The switch relay device according to claim 14, further comprising an application layer circuit which sends device information for a device from the memory through the network physical layer circuit to the host in accordance with the device connected by the switch to a device physical layer circuit.

16. The switch relay device according to claim 15, wherein the application layer circuit selectively provides data, which is transferred from the host, to the devices through the device physical layer circuits in accordance with requests from the host.

17. The switch relay device according to claim 12, wherein even when the switch selectively connects and disconnects the device physical layer circuits to the plurality of devices, data is transferred between a device connected through that device physical layer circuit and the network until the data transfer has completed.

18. The switch relay device according to claim 17, wherein the link layer circuit transfers data between the network physical layer circuit, and one of the device physical layer circuits to which a device is connected in accordance with the selection of the switch.
